(19) United States
(12) Patent Application Publication
(10) Pub. No.: US 2003/0221323 A1
(43) Pub. Date: Dec. 4, 2003

(54) Method and apparatus for securing a handle to a knife tang

(76) Inventors: Les DeAsis, West Linn, OR (US); Bruce Robert Troyan, Lake Oswego, OR (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/418,889

(22) Filed: Apr. 18, 2003

Related U.S. Application Data
(60) Provisional application No. 60/373,774, filed on Apr. 18, 2002.

(51) Int. Cl. B26B 1/00; B25G 1/00

(52) U.S. Cl. 30/329; 30/340

(57) ABSTRACT

The present invention relates to knives and related implements, and, more particularly, to methods and apparatus for attaching a handle to a tang of a knife. One aspect of the invention is for attaching a handle to a tang of a knife by removably coupling an insert having a threaded bore onto a portion of the tang, the insert being adapted to couple with a coupler, the coupler comprising a threaded rod and an expanded head, such as, but not limited to, a bolt. The engagement of the insert and the coupler pulls together the tang and the handle in removably coupling engagement.

### RELATED APPLICATIONS

This application claims the benefit of U.S. Provisional Application No. 60/373,774, filed Apr. 18, 2002.

### FIELD OF THE INVENTION

The present invention relates to knives and related implements, and, more particularly, to methods and apparatus for removably coupling a handle to a tang of a knife.

### BACKGROUND OF INVENTION

Knives and related implements, such as rifle bayonets and swords, are commonly constructed from an elongated metal blade having a cutting portion at one end and a tang at the opposite end upon which a handle is coupled. The handle is used as a grip for the hand of the user. There are a variety of methods of attaching the handle and ancillary components to the tang, including, but not limited to, the use of rivets, cast in place, and the use of threaded fasteners.

One method of handle attachment known in the art provides a tang that is threaded to accept a nut. The handle is slipped over the tang and the nut is advanced onto the tang to secure the handle between the cutting portion and the nut. The threads on the tang can be provided in a number of ways, such as, by welding a threaded rod to the end of the tang, and direct machining of the threads into the tang. Providing a threaded tang to facilitate handle attachment adds manufacturing steps to the knife fabrication process, which adds to the cost and time of manufacture.

Welding a threaded rod to the tang is not a preferred method as it not only adds to the manufacturing time and cost, but can weaken the metal blade causing cracking and failure. Heat treatment is commonly used to establish a material property favorable to the longevity of the cutting portion, but may not be suitable for threaded engagement which requires a relatively softer material property. The heat of welding will change the material property of the blade in undesirable ways which could lead to failure.

A knife used for military applications is required to have one or more specific characteristics. One characteristic is for the knife to be convertible from a handheld knife to a rifle bayonet. One way to accommodate this conversion is to have a handle coupling means that is amendable to disassembly and assembly in the field. Another characteristic is for the knife to accommodate and be interchangeable with the attachment of various handle pieces and ancillary components. For example, but not limited thereto, the knife may be required to have a removable finger guard between the cutting portion and the handle to be replaced with a rifle bracket to convert the knife to a bayonet.

Military specifications commonly require that the knife be functional, yet inexpensive. Therefore, specialized welding or other processes have proven expensive to meet the military supply specification as well as market competition. Further, the knife is required to be adapted for field use that requires, for example, ease of assembly/disassembly, interchangeability with other components in response to changing functionality, and be cost effective.

Therefore, apparatus and methods are needed that provide knives and similar implements that are relatively easy to assemble and disassemble the handle and ancillary components from the blade, and are not economically prohibitive to manufacture.

### BRIEF DESCRIPTION OF DRAWINGS

FIGS. 1 and 2 are side and top views, respectively, of a knife in accordance with an embodiment of the present invention;

FIGS. 3 and 4 are top and side longitudinal cross-sectional views about lines 3-3 and 4-4, respectively, of the embodiment of the knife of FIGS. 1 and 2, respectively;

FIG. 5 is a perspective view of one of two scales of a two piece handle, in accordance with an embodiment of the present invention;

FIGS. 6A and 6B are exploded and assembled perspective views, respectively, of the blade showing the tang, insert and the coupler, in accordance with an embodiment of the present invention; and

FIGS. 7, 8 and 9 are plan, side and perspective longitudinal cross-sectional views, respectively, of a knife including ancillary components in accordance with an embodiment of the present invention.

### DESCRIPTION

In the following detailed description, reference is made to the accompanying drawings which form a part hereof wherein like numerals designate like parts throughout, and in which is shown by way of illustration specific embodiments in which the present invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

The present invention relates to knives and related implements, and, more particularly, to methods and apparatus for removably coupling a handle to a tang of a knife. In accordance with an embodiment of the present invention, methods and apparatus are provided for removably coupling a handle to a tang of a knife by removably coupling an insert having a threaded bore, such as, but not limited to, a nut, onto the tang, the insert adapted to removably couple with a coupler, the coupler comprising a threaded rod and an expanded head, such as, but not limited to, a bolt. The engagement of the insert and the coupler pulls together the tang and the handle in removably coupling engagement.

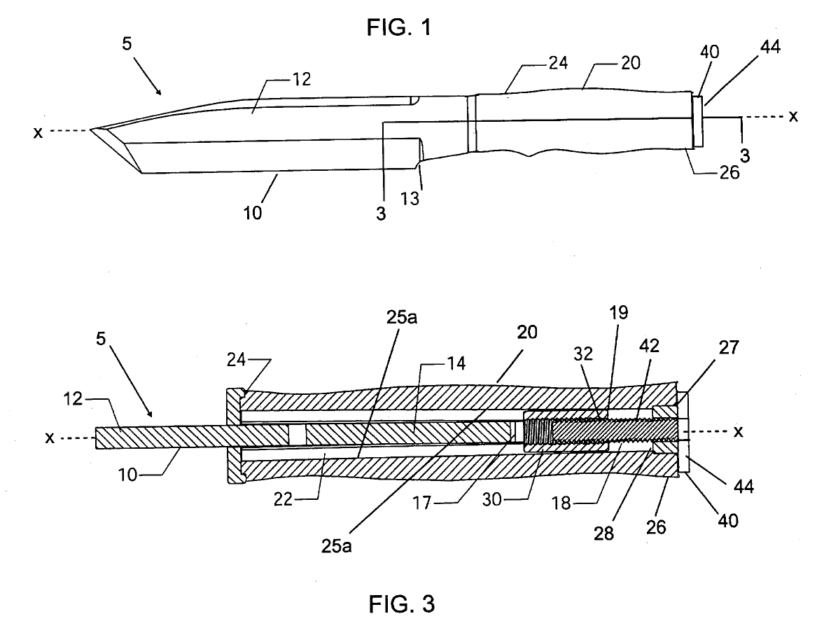

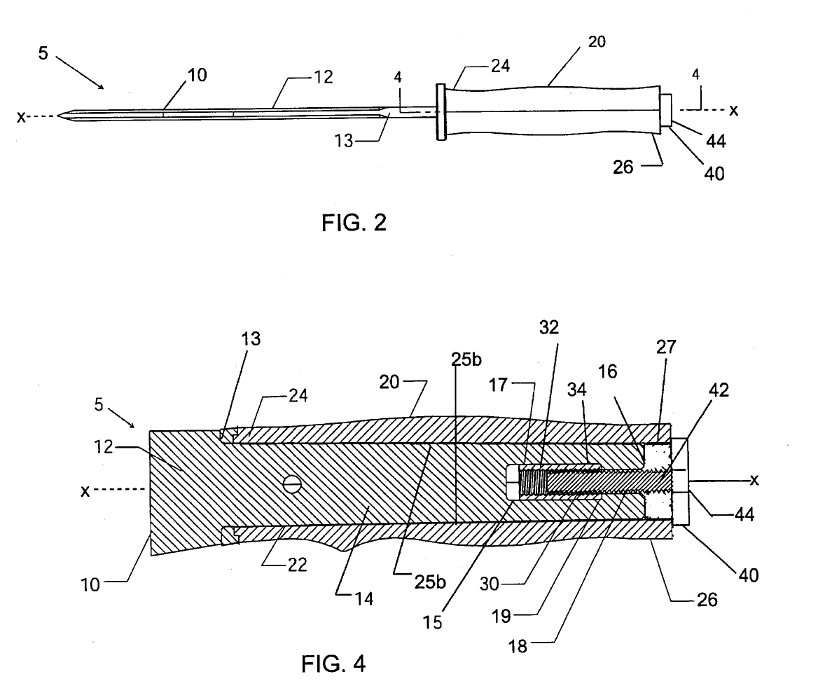

FIGS. 1 and 2 are side and top views, respectively, of a knife 5 in accordance with an embodiment of the present invention. FIGS. 3 and 4 are top and side longitudinal cross-sectional views about lines 3-3 and 4-4, respectively, of the knife 5 as shown in FIGS. 1 and 2, respectively. The knife 5 comprises a blade 10, a handle 20, an insert 30, and a coupler 40. The coupler 40, in cooperation with the insert 30, couples the handle 20 to the blade 10. The insert 30 is engaged by the blade 10 and retained therein, in part, by the handle 20. The coupler 40 is adapted to threadably engage the insert 30 to removably couple the handle 20 to the blade 10. When assembled, the blade 10 is at least partially contained within the handle 20 and at least partially extended from the handle 20.

The blade 10 has an elongated, substantially planar form, comprising a cutting portion 12 at one end, a tang 14 at an opposite end, and a blade shoulder 13 there between. The tang 14 has a substantially planar, rectangular form which extends substantially linearly along a longitudinal axis x-x from the blade shoulder 13 to a terminal end 16. The blade 10 comprises a material suitable for a particular purpose, such as, but not limited to, carbon steel, stainless steel, other metals and metal alloys, composites and plastics. The blade 10 is fabricated by a variety of known methods, including, but not limited to, forming, casting, machining, stamping, and cutting by laser or mechanical means from a blank of suitable material.

The handle 20 is an elongated member comprising a cavity 22 there through which extends substantially coaxial with the longitudinal axis x-x. The cavity 22 is adapted to accept at least a portion of the tang 14, but not the cutting portion 12 or blade shoulder 13, therein. The handle 20 comprises a tang receiving end 24 and a butt end 26 opposite the tang receiving end 24. During assembly, the tang 14 is slidably received and advanced into the cavity 22 at the tang receiving end 24. The butt end 26 has a butt end aperture 27 adapted to receive a portion of the coupler 40, as discussed below. The handle 20 comprises any material suitable for a particular purpose, such as, but not limited to, metal, composite, plastic, and wood.

The cavity 22 is adapted to facilitate the placement of the tang 14 therein. The shape of the cavity 22 is predetermined for a particular handle 20 to tang 14 cooperative engagement. A number of handle 20 to tang 14 cooperative engagement embodiments are anticipated. For example, but not limited thereto, in one embodiment the handle 20 to tang 14 cooperative engagement relies primarily on the tang 14 and/or the insert 30 being wedgedly engaged by tapered cavity walls 25a, 25b, as will be discussed below. In another example, but not limited thereto, in another embodiment the handle 20 to tang 14 cooperative engagement relies primarily on the engagement of the blade shoulder 13 and the tang receiving end 24 of the handle, as will be discussed below.

In an embodiment in accordance with the present invention, as shown in FIG. 3, the cavity 22 comprises cavity walls 25a, 25b, at least one of wish has an inward taper towards the butt end 26 such that the tang 14 engages the cavity walls 25a, 25b, as in a wedge, as the tang 14 is driven into the cavity 22 during assembly, effectively removably coupling the handle 20 to the tang 14.

In another embodiment, not shown, in accordance with the present invention, the cavity 22 comprises cavity walls 25a, 25b, at least one of wish has an inward taper towards the butt end 26 such that the insert 30 engages the cavity walls 25a, 25b, as in a wedge, as the tang 14 is driven into the cavity 22 during assembly, effectively removably coupling the handle 20 to the tang 14.

In another embodiment in accordance with the present invention, as shown in FIG. 4, the blade 10 comprises shoulders 13 adjacent the tang 14, wherein the tang receiving end 24 of the handle 20 abuts the shoulders 13 as the tang 14 is drawn into the cavity 22. The terminal end 16 of the tang 14 does not come into abutment with either the coupler 40 or portions of the handle 20 to ensure that the terminal end 16 does not hinder the advancement of the tang 14 into the cavity 22 to effect the engagement of the tang receiving end 24 with the blade shoulders 13, capturing and/or placing the handle 20 in compression, effectively removably coupling the handle 20 to the tang 14.

In yet another embodiment in accordance with the present invention, not shown, the terminal end 16 abuts the coupler 40 to capture and/or put the handle 20 into a compressed state between the blade shoulders 13 and the coupler 40, preventing the over tightening of the coupler 40.

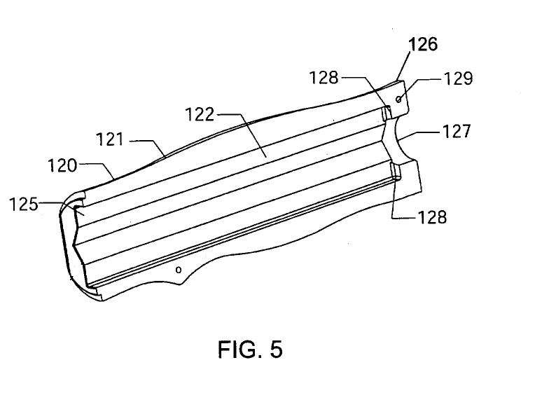

The handle 20 as shown in FIG. 4 is of a one piece construction. FIG. 5 is a perspective view of one of two half-handle pieces, known in the art as scales 121, of a two piece handle 120, in accordance with another embodiment of the present invention. Alignment features 129 are provided to guide the assembly and provide alignment of the two scales 121. The scales 121 comprise a cavity 122 adapted to accept the tang 14 and insert 30 when the scales 121 are brought together to surround the tang 14.

It is anticipated that other handle designs are suitable for a particular purpose in accordance with embodiments of the present invention. For example, but not limited thereto, the handle comprises a plurality of axial sections or rings, wherein, when advanced side-by-side onto the tang 14, forms the complete handle. One or more axial sections are interchangeable with other sections having features suitable for a particular purpose, or interchanged with other components, such as, but not limited to, a finger guard and a rifle bracket.

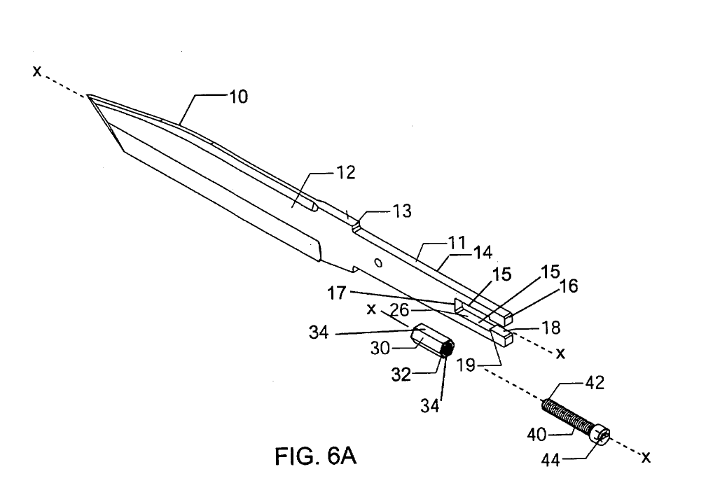

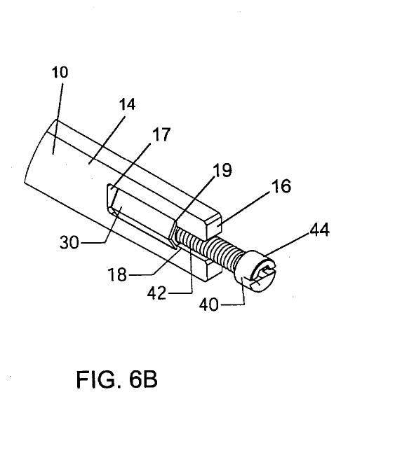

FIGS. 6A and 6B are exploded and assembled perspective views, respectively, of the blade 10 showing the tang 14, insert 30 and the coupler 40, without the handle 20 to simplify the view. The tang 14 further comprises an insert aperture 17 in communication with a coupler aperture 18 extending from the terminal end 16. The insert aperture 17 and coupler aperture 18 comprise a through slot in the tang 14, and are adapted to receive the insert 30 and at least a portion of the coupler 40, respectively. The coupler aperture 18 has a dimension that is smaller than the insert aperture 17 defining an aperture shoulder 19 there between. The aperture shoulder 19 is adapted to prevent the insert 30 from entering the coupling aperture 18 upon assembly. The coupler aperture 18 is adapted to provide an opening between the insert aperture 17 and the terminal end 16 to slidably receive a portion of the coupler 40 as discussed below.

The insert 30 comprises a threaded through bore 32 that extends substantially linearly along the longitudinal axis x-x. In accordance with another embodiment of the present invention, the threaded bore 42 of the insert 30 extends at least a predetermined distance into the insert 30 and is adapted to accept a portion of the coupler 40 without the coupler 40 bottoming out in the bore 32.

The insert 30 has a predetermined outer dimension adapted for cooperative engagement with the insert aperture 17. Upon assembly, the insert aperture 17 is adapted to slidably receive the insert 30. The engagement of the insert aperture 17 and the insert 30 substantially prevents rotation of the insert 30 about the longitudinal axis x-x caused by the torque of the coupler 40 during assembly.

The insert 30 is adapted to be retained by the insert aperture 17 with the bore 32 of the insert 30 in substantial coaxial alignment with the longitudinal axis x-x and therefor the coupler aperture 18, such that the coupler 40 can threadably engage the bore 16 from the terminal end 16 through the coupler aperture 18.

In an embodiment in accordance with the present invention, the insert 30 comprises parallel insert sides 34 adapted for cooperative engagement with complimentary parallel aperture sides 15 of the insert aperture 17. The parallel insert sides 34 and aperture sides 15 provide for sliding engagement, as well as a “keying” function that guides the insert 30 into the insert aperture 17 in a predetermined orientation and is substantially constrained to that orientation by the close engagement of the insert sides 34 and aperture sides 15.

The insert 30 shown in FIG. 6A has a hexagon form, such as provided by, but not limited to, a hex nut, with three pairs of parallel sides 34, one or more of which is adapted to slidably engage the insert aperture 17. Other forms of the insert 30 is anticipated, such as, but not limited to, rectangular, square, and other forms having at least two flat sides 34. In another embodiment in accordance with the present invention, the insert 30 is cylindrical in form, though the alignment of the bore 32 with the coupler aperture 18 is more challenging.

The coupler 40 is adapted to threadably engage the bore 32 of the insert 30 while also engaging the butt end 26 of the handle 20 to couple the handle 20 to the tang 14. In an embodiment in accordance with the present invention, the coupler 40 comprises a threaded rod 42 and a head 44. The head 44 is adapted to provide specific retention needs suitable for a particular purpose. In the embodiment of FIG. 4, the head 44 has a predetermined dimension adapted to abut the butt end 26 of the handle 20 when assembled. In other embodiments in accordance with the present invention, the head 44 has a predetermined dimension that is larger than the diameter of the coupler aperture 18, preventing advancement of the head 44 into the coupler aperture 18.

Upon assembly, the insert 30 is received into the insert aperture 17 such that the bore 32 of the insert 30 is in coaxial alignment with the longitudinal axis x-x and therefore, in alignment with the coupler aperture 18 of the tang 14 and the butt end aperture 27 of the handle 20. The rod 42 of the coupler 40, as shown in FIG. 4, is adapted to pass through the butt end aperture 27 and the coupler aperture 18 to threadably engage the bore 32 of the insert 30, as shown in FIG. 4.

In an embodiment in accordance with the present invention wherein the handle 20 is a one-piece design, the tang 14 is adapted to be slidably received into the cavity 22 of the handle 20 at the tang receiving end 24. The cavity 22 is adapted to substantially conform to the form of the insert 30/tang 14 assembly.

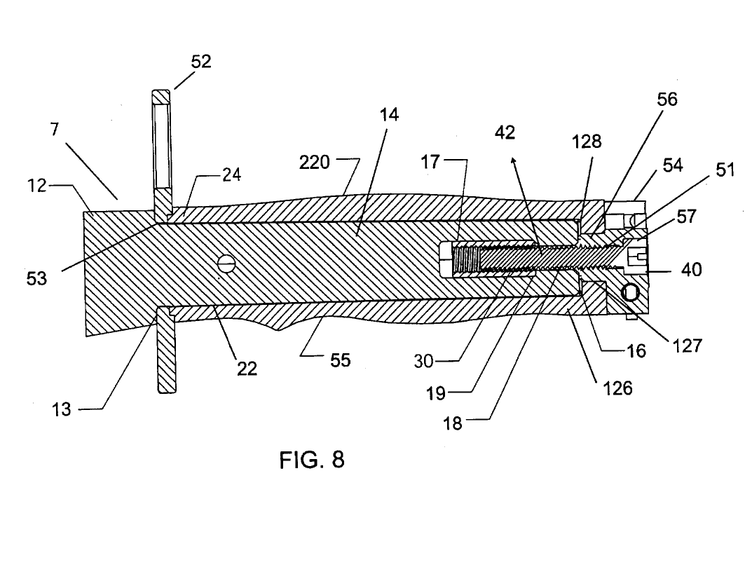

The specific engagement condition between the cavity 22 and the tang 14/insert 30 when assembled is predetermined for a particular purpose. As previously discussed, in the embodiment of FIG. 3, the cavity 22 comprises inwardly tapered sides 25a that taper from the tang receiving end 24 to the butt end 26. The tapered sides 25a are adapted such that as the tang 14 is drawn into the cavity 22 by the threaded engagement of the rod 42 of the coupler 40 with the bore 32 of the insert 30, the insert 30 comes into urging engagement with the cavity sides 25a. The tang 14 has a predetermined length adapted such that the tang terminal end 16 does not come into abutment with the head 44 as shown in FIG. 4, or the cavity shoulder 128 of another embodiment as shown in FIG. 8. Whereas the tang terminal end 16 does come into abutment with the head 44 or the cavity shoulder 128, the blade 10 will no longer be drawn into the handle 20, potentially resulting in the handle 20 being captured onto the tang 14 in a loose coupled condition about the tang 14.

The tapered sides 23 also assist in restricting the rotation of the tang 14 during assembly, in particular, if the cavity 22 does not sufficiently conform to the form of the tang 14. Other “keying” methods may be used such that the tang 14 and handle 20 cooperate to prevent rotation of the tang 14 within the cavity 22 during assembly and disassembly, such as provided by the cavity sides 125, as shown in FIG. 5, that substantially conform to the rectangular form of the tang 14 and provide clearance for the insert 30.

In an embodiment in accordance with the present invention, not shown, the cavity 22 is inwardly tapered from the tang receiving end 24 to the butt end 26. As the tang 14 is drawn into the cavity 22 by the threaded engagement of the rod 42 with the bore 32, the tang sides 11, as shown in FIG. 6A, comes into urging engagement with the cavity sides 25b. Similarly, as in the embodiment above, the tang 14 has a predetermined length adapted such that the tang terminal end 16 does not come into abutment with the head 44 as shown in FIG. 4, or the cavity shoulder 128 as shown in FIG. 8.

In accordance with an embodiment of the method of the present invention, the knife 5 is assembled by slidingly engaging the insert 30 into the insert aperture 17 of the tang 14 such that the bore 32 of the insert 30 is substantially in coaxial aligmnent with the longitudinal axis x-x, and therefore, aligned with the coupler aperture 18 of the tang 14 and the butt end aperture 27 of the handle 20. The tang 14 is slidingly inserted into the tang receiving end 24 of the one-piece handle 20, or surrounded by the assembled scales 121 of the multi-piece handle 120. The rod 42 of the coupler 40 is slidingly received through the butt end aperture 27 of the handle 20 and the coupler aperture 18 of the tang 14, to threadably engage the bore 32 of the insert 30, as shown in FIG. 4. In the case of the multi-piece handle 120, the rod 42 of the coupler 40 is slidingly received through the butt end aperture 127 of the handle 120 and the coupler aperture 18 of the tang 14, to threadably engage the bore 32 of the insert 30.

The threaded rod 42 is advanced into the bore 32 of the insert 30 causing the head 44 to come into urging engagement with the handle butt end 26, as well as the insert 30 to come into urging engagement with the aperture shoulder 19. Further advancement of the coupler 40 draws the tang 14 further into the cavity 22 towards the butt end 26. A portion of the tang 14 and/or the insert 30 is driven against the tapered sides 25a, 25b of the cavity 22 in urging engagement, effectively removably coupling the handle 20 to the tang 14.

In accordance with another embodiment of the present invention, the length of the tang 14 has a predetermined length adapted such that the tang terminal end 16 does not come into contact with the cavity shoulder 33 or the head 44 during assembly. The tang 14 is further adapted such that the tang 14 does not come into urging engagement with the cavity sides 25a, 25b. The length of the tang 14 is adapted such that the blade shoulders 13 come into abutment and/or urging engagement with the tang receiving end 24 of the handle 20, as well as the head 44 to come into abutment and/or urging engagement with the butt end 26. The handle 20 is thus captured and/or put into a compressed state by the tension between the coupler 40 and the blade 10, effectively removably coupling the handle 20 to the tang 14.

In accordance with an embodiment of the method of the present invention, the knife 5 is assembled by advancing the insert 30 into the insert aperture 17 of the tang 14 such that the bore 32 is in substantial coaxial alignment with the longitudinal axis x-x of the blade 10. The tang 14 is inserted into the tang receiving end 24 of the handle 20. The rod 42 of the coupler 40 is slidingly received through the butt end aperture 27 of the handle 20 and the coupler aperture 18 of the tang 14, to threadably engage the bore 32 of the insert 30. The rod 42 is threadably engaged into the bore 32 of the insert 30 to cause the head 44 to urge against the butt end 26 of the handle 20, as well as the insert 30 to urge against the aperture shoulder 19. Further advancement of the coupler 40 draws the tang 14 further into the cavity 22 towards the butt end 26 until the blade shoulders 13 abut the tang receiving end 24 of the handle 20 in urging engagement, effectively removably coupling the handle 20 to the tang 14.

The knife 5 is adapted to be disassembled by advancing the rod 42 out of the bore 32, the coupler aperture 18, and the butt end aperture 27, and slidingly removing the handle 20 from the tang 14, and slidingly removing the insert 30 from the insert aperture 17. The ease of disassembly provides for the replacement of the components of the knife 5, for example, but not limited to, the replacement of a damaged insert 30. Further, the knife 5 is adapted to be disassembled and reassembled to provide for the attachment and interchangeability of ancillary components, as discussed below.

A desired feature, often required for military applications, is the coupling of ancillary components onto the knife 5. Ancillary components include, but are not limited to, a finger guard, hand guard, and rifle bracket, that are coupled to the blade 10 positioned between the blade shoulder 13 and the handle 20. Other ancillary components, including, but not limited to, a latch assembly and butt end protector, are coupled to the knife 5 positioned at the butt end 26 of the handle 20. The removable coupling features of embodiments of the present invention provide for assembly and interchangeability of single or combinations of ancillary components onto the knife 5.

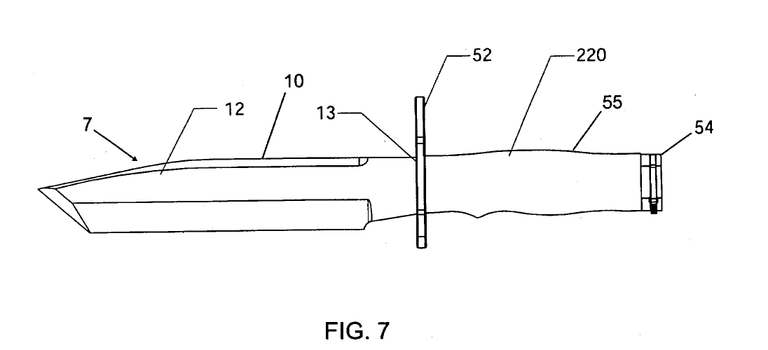

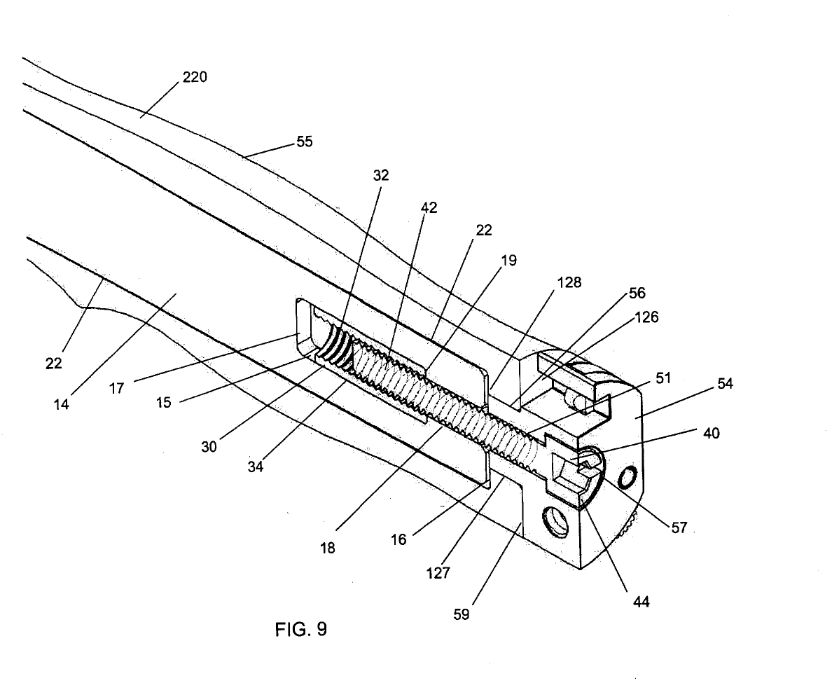

FIGS. 7, 8 and 9 are plan, side and perspective longitudinal cross-sectional views, respectively, of a knife 7 in accordance with an embodiment of the present invention. The knife 7 further comprises a rifle bracket 52, such as associated with a bayonet, coupled on the blade 10 between the blade shoulder 13 and the handle 220. The rifle bracket 52 comprises a bracket aperture 53 which is adapted to slidingly engage the tang 14 and be advanced to abut the blade shoulder 13 prior to handle 220 assembly. The rifle bracket 52 is secured to the blade 10 upon engagement of the coupler 40 with the insert 30 and the butt end 126, in urging engagement between the blade shoulder 13 and the tang receiving end 24.

In accordance with another embodiment of the present invention, a finger guard (not shown) is adapted to couple with the blade 10 in substantially similar arrangement as the rifle bracket 52 described above. The knife 7, therefore, is adapted for the interchangeability of ancillary components, such as, but not limited to, the finger guard with the rifle bracket 52.

In accordance with an embodiment of the present invention, a latch assembly 54 is adapted to be assembled adjacent the butt end 26 of the handle 220 and coupled by the engagement of the coupler 40 with the insert 30 and the latch assembly 54. The latch assembly 54 comprises a bushing 56 adapted to be slidably received into the butt end aperture 127. The latch assembly 54 further comprises a latch aperture 51 adapted to slidingly receive the rod 42 of the coupler 40, such that the head 44 comes into urging engagement with and secures the latch assembly 54 to the butt end 126 as the rod 42 engages the bore 32. The latch assembly 54 further comprises a countersink recess 57 adapted to receive therein the head 44, wherein once engaged with the insert 30, the head 44 is flush with or recessed within the latch assembly 54.

In accordance with another embodiment of the present invention, a butt cap (not shown) is adapted to couple with the blade 10 in substantially similar arrangement as the latch assembly 54 above. The butt cap is adapted to provide the bushing 56 and the countersink recess 57 in similar form as the latch assembly 54. The butt cap provides protection for the butt end 126 as well as the esthetic appeal of a countersunk head 44.

It is noted that should the insert 30 become damaged in any way during assembly/disassembly of the knife 5, the insert 30 is easily removed from the insert aperture 17 with no appreciable detrimental affect on the tang 14. Thereafter, a new insert 30 is inserted within the insert aperture 17 in accordance with embodiments of the present invention.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein.

What is claimed is:

1. A knife, comprising:
a blade having a cutting portion at an end and a tang at an opposite end;
a handle having a cavity and a butt end aperture, the cavity removably coupled with at least a portion of the tang extending into the cavity;
an insert having a threaded bore and removably coupled with a portion of the tang; and
a coupler having a threaded rod and a head, the rod extending through the butt end aperture and threadably engaged with the bore, and the head in urging engagement with the handle.

2. The knife of claim 1, wherein the tang comprises:
a terminal end distal from the cutting portion;
a coupler aperture proximate to and in communication with the terminal end; and
an insert aperture proximate to and in communication with the coupler aperture;
the blade further comprising a longitudinal axes, the coupler aperture and the insert aperture in substantial alignment with the longitudinal axis, the insert received by the insert aperture, the bore in substantial alignment with the longitudinal axis, at least a portion of the coupler slidingly received by the coupler aperture there through, the rod extending through the butt end aperture to the bore, the insert aperture and coupler aperture defining an aperture shoulder there between, the insert in urging engagement with the aperture shoulder.

3. The knife of claim 1, wherein:
the blade further comprising a longitudinal axis and a blade shoulder between the cutting portion and the tang, the tang comprising a terminal end distal from the blade shoulder, a coupler aperture in communication with the terminal end, and the insert aperture in communication with the coupler aperture, the coupler aperture and the insert aperture in substantial alignment with the longitudinal axis;
the handle further comprising a tang receiving end and a butt end opposite the tang receiving end, the cavity extending substantially coaxial with the longitudinal axis, the tang at least partially received within the cavity at the tang receiving end, the butt end comprising the butt end aperture substantially coaxial with the longitudinal axis, the rod slidingly received within the butt end aperture there through, the tang receiving end in urging abutment with the blade shoulder;
at least a portion of the insert slidingly received within the insert aperture, the bore substantially coaxial with the coupler aperture and the butt end aperture; and
the rod slidingly received by the coupler aperture there through, the rod threadably engaged with the bore and the head in urging engagement with the butt end of the handle, and the tang receiving end in urging engagement with the blade shoulder.

4. The knife of claim 1, wherein:
the blade further comprising a longitudinal axis, the tang comprising a terminal end distal from the cutting portion, a coupler aperture in communication with the terminal end, and the insert aperture in communication with the coupler aperture, the coupler aperture and the insert aperture in substantial alignment with the longitudinal axis;
the handle further comprising a tang receiving end and a butt end opposite the tang receiving end, the cavity extending substantially coaxial with the longitudinal axis, the tang at least partially received within the cavity at the tang receiving end, the butt end comprising the butt end aperture substantially coaxial with the longitudinal axis, the rod slidingly received within the butt end aperture there through;
at least a portion of the insert slidingly received within the insert aperture, the bore substantially coaxial with the coupler aperture and the butt end aperture;
the rod slidingly received by the coupler aperture there through, the rod threadably engaged with the bore and the head in urging engagement with the butt end of the handle; and
the cavity comprising at least one tapered side having an inward taper from the tang receiving end to the butt end, at least a portion of the tang engaged with the cavity.

5. The knife of claim 1, wherein:
the blade further comprising a longitudinal axis, the tang comprising a terminal end distal from the cutting portion, a coupler aperture in communication with the terminal end, and the insert aperture in communication with the coupler aperture, the coupler aperture and the insert aperture in substantial alignment with the longitudinal axis;
the handle further comprising a tang receiving end and a butt end opposite the tang receiving end, the cavity extending substantially coaxial with the longitudinal axis, the tang at least partially received within the cavity at the tang receiving end, the butt end comprising the butt end aperture substantially coaxial with the longitudinal axis, the rod slidingly received within the butt end aperture there through;
at least a portion of the insert slidingly received within the insert aperture, the bore substantially coaxial with the coupler aperture and the butt end aperture;
the rod slidingly received by the coupler aperture there through, the rod threadably engaged with the bore and the head in urging engagement with the butt end of the handle; and
the cavity comprising at least one tapered side having an inward taper from the tang receiving end to the butt end, at least a portion of the insert engaged with the cavity.

6. The knife of claim 3, wherein the insert aperture further comprises at least two aperture sides, the insert comprising at least two insert sides in complimentary relationship with the aperture sides, the insert at least partially slidingly received within the insert aperture in a predetermined orientation.

7. The knife of claim 4, wherein the insert aperture further comprises at least two aperture sides, the insert comprising at least two insert sides in complimentary relationship with the aperture sides, the insert at least partially slidingly received within the insert aperture in a predetermined orientation.

8. The knife of claim 5, wherein the insert aperture further comprises at least two aperture sides, the insert comprising at least two insert sides in complimentary relationship with the aperture sides, the insert at least partially slidingly received within the insert aperture in a predetermined orientation.

9. A method for removably coupling a handle to a knife tang, comprising:
providing a knife, comprising:
a blade having a cutting portion at an end and a tang at an opposite end, the tang having a coupler aperture in communication with the terminal end, and an insert aperture in communication with the coupler aperture;
a handle having a tang receiving end, a butt end, and a cavity adapted to accept at least a portion of the tang therein;
an insert having a threaded bore, the insert adapted to couple with a portion of the tang; and
a coupler having a head and a threaded rod, the head adapted to engage the butt end and the rod adapted to threadably engage the bore of the insert;
advancing the insert into the insert aperture of the tang and aligning the bore with the longitudinal axis and the coupling aperture;
advancing the tang and insert into the cavity at the tang receiving end of the handle;
advancing the rod through the butt end aperture, through the coupler aperture, and into the bore; and
threadably engaging the rod within the bore drawing the tang into the cavity.

10. The method of claim 9, the cavity further comprising at least one inwardly tapered side extending from the tang receiving end to the butt end, wherein threadably engaging the rod within the bore drawing the tang into the cavity comprises threadably engaging the rod within the bore drawing the tang into the cavity until a portion of the insert is in abutment and wedged within the inwardly tapered sides.

11. The method of claim 9, the cavity further comprising at least one inwardly tapered side extending from the tang receiving end to the butt end, wherein threadably engaging the rod within the bore drawing the tang into the cavity comprises threadably engaging the rod within the bore drawing the tang into the cavity until a portion of the tang is in abutment and wedged within the inwardly tapered sides.

12. The method of claim 9, wherein the blade further comprises a blade shoulder between the cutting portion and the tang, and wherein threadably engaging the rod within the bore drawing the tang into the cavity comprises threadably engaging the rod within the bore drawing the tang into the cavity, the handle in urging engagement with the blade shoulder and the head.

13. The method of claim 12, further comprising:
providing a rifle bracket having an aperture adapted to accept the tang there through; and
advancing the bracket on the tang and in abutment with the shoulder and advancing the handle onto the tang in abutment with the rifle bracket.

14. The method of claim 12, further comprising:
providing a butt end component, the butt end component having a component aperture adapted to accept the rod there through; and
advancing the rod through the component aperture prior to advancing the rod through the butt end aperture.

15. A knife comprising:
a blade having a cutting portion and a tang distal from the cutting portion and extending generally along a longitudinal axis, the tang having a terminal end distal from the cutting portion;
a handle removably coupled to the tang, the handle having a tang receiving end and a butt end with a cavity there between, the butt end having a butt end aperture substantially coaxial with the longitudinal axis, at least a portion of the tang including the terminal end extending into the cavity from the tang receiving end;
a coupler having a head and a threaded rod distal from the head;
a tang aperture extending from the terminal end into the tang substantially coaxial with the longitudinal axis, the tang aperture having a laterally enlarged portion spaced from the terminal end; and
an insert having a portion positioned within the enlarged portion, the insert having a threaded bore in substantial coaxial alignment with the longitudinal axis and open to the terminal end, the rod extending forewardly from the butt end in a direction toward the cutting portion substantially coaxial with the longitudinal axis and through the butt end aperture and the tang aperture and threadably coupled with the bore.

16. The knife of claim 15, wherein the enlarged portion further comprises at least two aperture sides, the insert further comprises at least two insert sides in complimentary relationship and aligning engagement with the at least two aperture sides.

17. The knife of claim 15, wherein the blade further comprises a blade shoulder between the cutting portion and the tang, the tang receiving end in urging engagement with the bald shoulder and the head in urging engagement with the butt end.

18. The knife of claim 15, wherein the cavity comprises at least one inwardly tapered side extending from the tang receiving end to the butt end, the insert in urging engagement with the cavity.

19. The knife of claim 15, wherein the cavity comprises at least one inwardly tapered side extending from the tang receiving end to the butt end, the tang in urging engagement with the cavity.

20. The knife of claim 15, further comprising a rifle bracket removably coupled to the tang adjacent the cutting portion, the tang receiving end in urging engagement with the rifle bracket.

21. The knife of claim 15, further comprising a butt piece removably coupled adjacent the butt end and in urging engagement with the head.

22. A method for removably coupling a handle to a tang of a knife blade, the blade extending along a longitudinal axis and having a cutting portion at a first end and the tang at a second end opposite the first end, the method comprising:
forming an aperture in the tang extending substantially along the longitudinal axis from a terminal end of the tang, the aperture having a laterally enlarged portion spaced from the terminal end;
positioning an insert having a threaded bore into the enlarged portion, the bore extending substantially along the longitudinal axis;
inserting the tang through a longitudinally extending opening in the handle, the handle having a butt end having an opening of a smaller dimension than the longitudinally extending opening;
providing a coupler comprising a threaded rod and a head;
advancing the rod through the opening in a butt end of the handle and through the aperture to engage the bore of the insert; and
threadably engaging the rod with the bore and drawing the tang into the handle.

23. The method of claim 22, wherein threadably engaging the rod with the threaded bore and drawing the tang into the handle, comprises threadably engaging the rod with the threaded bore and drawing the tang into and in wedged engagement with tapered sides of the elongated opening in the handle.

24. The method of claim 22, wherein threadably engaging the rod with the threaded bore and drawing the insert into the handle, comprises threadably engaging the rod with the threaded bore and drawing the insert into and in wedged engagement with tapered sides of the elongated opening in the handle.

25. The method of claim 22, wherein the blade further comprising a blade shoulder between the cutting portion and the tang, wherein threadably engaging the rod with the threaded bore and drawing the tang into the handle, comprises threadably engaging the rod with the threaded bore and drawing the handle into engagement with the blade shoulder and the head.
